(19) United States
(12) Patent Application Publication
(10) Pub. No.: US 2004/0045322 A1
(43) Pub. Date: Mar. 11, 2004

(54) Fiber optic union, an apparatus for making said union with a controlled laser, and methods of making and using thereof

(76) Inventor: Griffin Stephen, Phoenix, AZ (US)

Correspondence Address: The Halvorson Law Firm, Ste 1, 405 W. Southern Ave., Tempe, AZ, 85282, US

(21) Appl. No.: 10/237,525

(22) Filed: Sep. 6, 2002

(51) Int. Cl. C03B 23/00

(52) U.S. Cl. 65/392; 65/108; 65/DIG. 9; 428/34.4

(57) ABSTRACT

Method and apparatus for providing a linearly or non-linearly tapered bore, with minor undulations within the bore wall, in vitreous tubing includes a laser and elements for focusing the laser onto the vitreous tubing. The vitreous tubing is rotated in the laser beam and is moved in the laser beam to provide a taper in the interior bore. The power of the laser beam is controlled and a lens, to provide a desired width of the beam at the vitreous tubing to produce the desired features, appropriately focuses the laser beam.

### FIELD OF THE INVENTION

This invention relates to vitreous unions that are used to couple glass and silica capillary elements together, their use and methods of their manufacture.

### BACKGROUND OF THE INVENTION AND DESCRIPTION OF THE PRIOR ART

U.S. Pat. No. 4,185,883 (Chown et al) discloses an optical fiber coupling element that includes a glass sleeve secured to a length of optical fiber. The optical fiber is placed in the glass sleeve, and the sleeve is heated so that it collapses around the fiber to hold the fiber in place.

U.S. Pat. No. 4,869,745 (Flaming) discloses a micropipette puller that includes a mirror that is oscillated to move energy of a laser along a selected portion of glass tubing. The mirror varies the amount of heat transmitted to the glass tubing as the tubing is being pulled.

U.S. Pat. No. 4,921,522 (Flaming) discloses a variation of the '745 Patent. The '522 Patent is a Continuation-in-Part of the '745 Patent. A concave mirror is used in the '522 Patent to direct the energy from a laser against glass tubing being pulled.

It will be noted that none of the above-described patents refers to providing a non-linear taper in the glass or quartz tubing elements involved in the patents.

U.S. Pat. No. 5,512,078 (Griffin) discloses a smooth surfaced linearly tapered bore, formed from glass tubing and using a controlled laser apparatus.

It will be noted that the above-described patent describes unions for highly circular cross-section capillary elements.

### SUMMARY OF THE INVENTION

The invention claimed and described herein comprises a linear taper in vitreous tubing for connecting capillary circular and non-circular cross-section capillary elements, and the method and apparatus for making said linear connecting union.

Energy from a laser is modulated by a chopper, which comprises rotating blades moved into and out of the laser beam. The modulated energy from the laser is directed against a rotating glass/quartz/silica tube through a focusing lens. The glass/quartz/silica tube is rotated and is moved, either in space or in time, in the laser beam. The more intense the beam, or the longer the beam impinges on a particular location of the glass tubing, the more the tubing bore collapses. Linear movement of the tubing in rotation and linear laser energy ramps result in linearly tapered interior bore of the quartz/glass/silica tubing. Application of energy of sufficient energy density and/or rapid, linear movement within the focal point of the laser forms a linear taper with slightly raised spiral ridges.

Among the objects of the present invention are the following:

To provide a new, non-linear taper in vitreous tubing;

To provide a new and useful method for obtaining a non-linear taper in vitreous tubing;

To provide a new and useful apparatus for non-linearly tapering the interior bore of vitreous tubing;

To provide a new, linear taper in vitreous tubing;

To provide a new and useful method for obtaining a linear taper in vitreous tubing;

To provide a new and useful apparatus for linearly tapering the interior bore of vitreous tubing;

To provide a new and useful apparatus for forming unions for joining capillary elements of similar and dissimilar diameters;

To provide a new and useful apparatus for forming unions for joining capillary elements with non-circular shapes; and

The novel features that are considered characteristic of the invention are set forth with particularity in the appended claims. The invention itself, however, both as to its structure and its operation together with the additional objects and advantages thereof will best be understood from the following description of the preferred embodiment of the present invention. Unless specifically noted, it is intended that the words and phrases in the specification and claims be given the ordinary and accustomed meaning to those of ordinary skill in the applicable art or arts. If any other meaning is intended, the specification will specifically state that a special meaning is being applied to a word or phrase. Likewise, the use of the words “function” or “means” in the Description of Preferred Embodiments of the invention is not intended to indicate a desire to invoke the special provision of 35 U.S.C. §112, paragraph 6 to define the invention. To the contrary, if the provisions of 35 U.S.C. §112, paragraph 6, are sought to be invoked to define the invention(s), the claims will specifically state the phrases “means for” or “step for” and a function, without also reciting in such phrases any structure, material, or act in support of the function. Even when the claims recite a “means for” or “step for” performing a function, if they also recite any structure, material or acts in support of that means of step, then the intention is not to invoke the provisions of 35 U.S.C. §112, paragraph 6. Moreover, even if the provisions of 35 U.S.C. §112, paragraph 6, are invoked to define the inventions, it is intended that the inventions not be limited only to the specific structure, material or acts that are described in the preferred embodiments, but in addition, include any and all structures, materials or acts that perform the claimed function, along with any and all known or later-developed equivalent structures, materials or acts for performing the claimed function.

### BRIEF DESCRIPTION OF THE DRAWING

FIG. 1 is a stomatic diagram of the apparatus for making the present invention.

FIG. 2 is the view in partial section taken generally along line 2-2 of FIG. 1.

FIG. 3 is a side view in partial section of vitreous tubing representative of the prior art.

FIG. 4 is a side view in partial section of vitreous tubing made with the apparatus and by the method of the present invention.

FIG. 5 is a block diagram illustrating the control systems of the present invention.

FIG. 6 is a side view in partial section through a union of the present invention.

FIG. 7 is a side view in partial section of a splitter precursor of the present invention.

FIGS. 8A, 8B, 8C, 8D, and 8E are sequential views in partial section illustrating the making of a splitter of the present invention.

FIGS. 9,10, and 11 are side views in partial section illustrating the use of elements made by the present method and apparatus in their use environments.

### DESCRIPTION OF THE PREFERRED EMBODIMENT

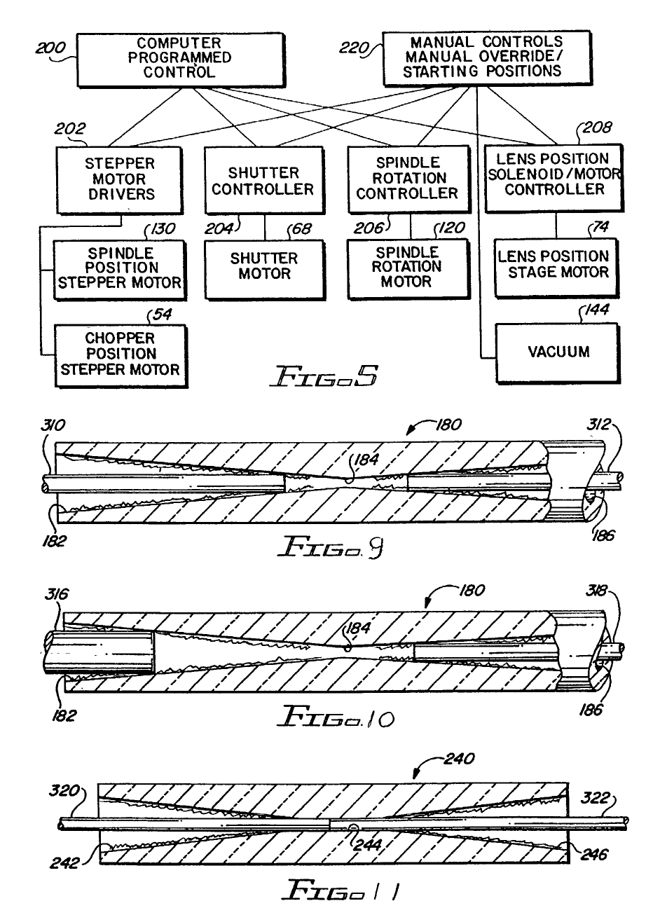

A coupling element or union 160 of non-linear prior art is illustrated in FIG. 3. FIG. 3 comprises a view in partial section through the coupling portion of the quartz-tubing union 160. A coupling element of union 180 of linear taper prior art is illustrated in FIG. 4, comprising a view in partial section through the coupling portion of the quartz tubing union.

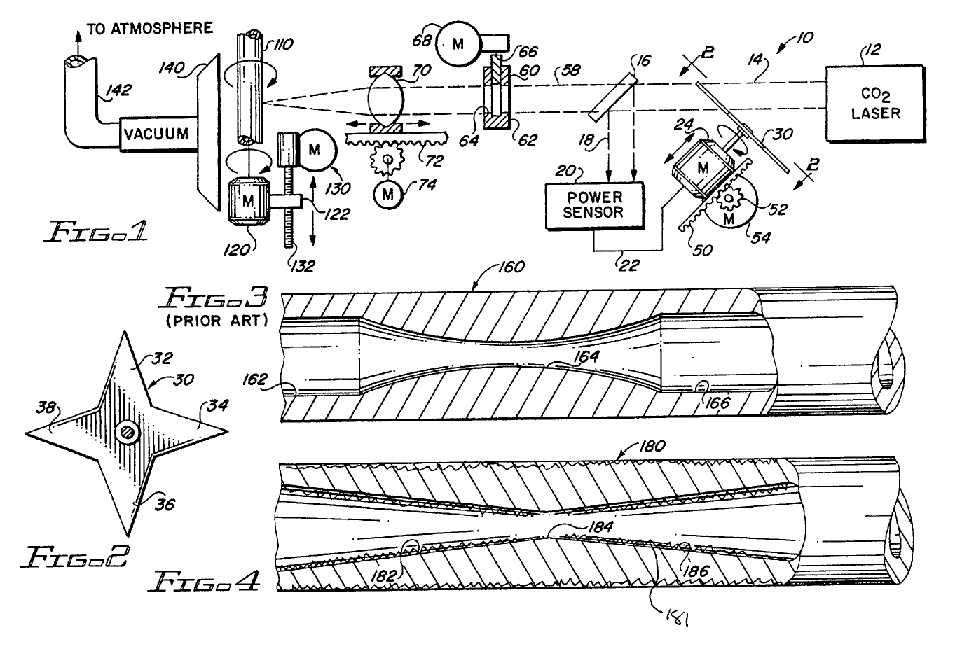

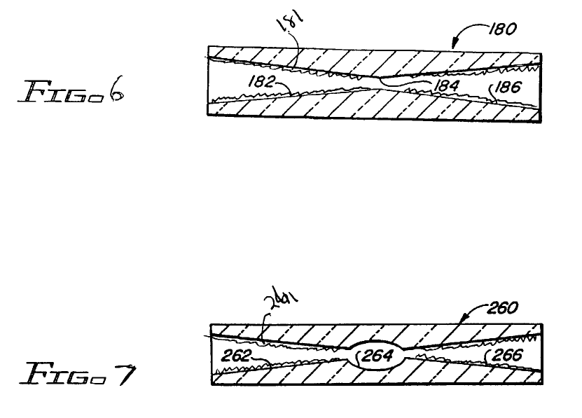

FIG. 7 is a side view in partial section of a union or coupling element 260 made by the apparatus of FIG. 1. The cross sectional configurations of the ferrule or coupling elements 160, 180 and 260 are clearly set forth.

In FIG. 3, the coupling element 160 includes a bore 162 and a bore 166 spaced apart from each other and separated by a coupling bore 164. The bores 162 and 166 have a relatively constant diameter, while the bore 164 has a varying diameter. When examined along the length of the bore, the diameter of the bore 164 is curved.

For the coupling element or union 180 of FIG. 4, there are two linearly tapered bore portions 182 and 186 that taper inwardly towards a minimum diameter portion or throat 184. The linear bores 182 and 186 may be similar or dissimilar in the shape of their taper, which taper is a uniform taper. Additionally, there is a groove or raised pattern 181 that is manufactured on at least the inner diameter of the union 180, such as in bores 182 and 186, respectively.

For the coupling element or union 260 of FIG. 7, there are two linearly tapered bore portions 262 and 266 that taper inwardly towards a minimum diameter portion or throat 264. The linear bores 262 and 266 may be similar or dissimilar in the shape of their taper, which taper is a uniform taper. Additionally, there is a groove or raised pattern 261 that is manufactured on at least the inner diameter of the union 260, such as in bores 262 and 266, respectively.

The apparatus of FIG. 1 is used to make the patterns 261 and tapers 262 and 266 of the union 260. The apparatus of FIG. 1 includes a carbon dioxide laser 12, which provides an output light beam 14. The power of the output light beam 14 is directed toward a beam splitter 16. The beam splitter 16 reflects a portion 18 of the beam 14 to a power sensor 20.

The power sensor 20 senses the power output of the laser 12. The laser power is modulated as appropriate through a pair of motors. The motors include a motor 24 that is coupled to a chopper 30. The chopper 30 comprises a configured disk having a plurality of blades, and the blades rotate in the path of the beam 14. The motor 24 rotates the chopper 30.

The motor 24 is mounted on a rack 50 that is coupled to a pinion gear 52. The pinion gear 52 is in turn coupled to the output shaft of a reversible motor 54. Rotation of the gear 52 by the motor 54 moves the chopper motor 24 towards and away from the beam 14.

FIG. 2 comprises a front or plan view of the chopper 30. FIG. 2 is taken generally along line 2--2 of FIG. 1.

The chopper 30, as indicated above, comprises a disk having a plurality of blades. The chopper 30 is illustrated as having four blades, including blades 32, 34, 36, and 38. The configuration of the blades 32, 34, 36, and 38 provides a varying amount of surface area that reflects energy from the light beam 14 to a beam dump (not shown). The tips of the blades are the thinnest portions, and the thickness of the blades increases as the blades 32 . . . 38 go inwardly towards the shaft to which they are secured.

Stated in the opposite manner, the thickness of the blades 32 . . . 38 tapers outwardly from a maximum to a minimum at the outer distal point or tips of the blades. The geometry or blade configuration may vary, as desired. The geometry of the blades varies the amount of energy from the beam 14 that is used, ultimately, in the manufacture of elements, such as the union 180 of FIG. 6, as the chopper 30 is moved into and out of the beam 14.

It will accordingly be understood that the closer to the beam 14 that the chopper center is, the greater the amount of that energy will be reflected by the chopper and the lesser the amount of energy that will be directed to the splitter 16 and onward from there, as will be discussed below.

For maximum energy transmitted onward, the chopper 30 will be moved away from the beam 14 and will thus have a minimum surface area directed into the beam 14, or no surface within the beam at all.

By varying the location of the chopper 30 relative to the output beam 14 of the laser 2, the output of the beam 14 may be modulated or controlled as desired.

While a small portion 18 of the beam 14 is directed by the splitter 16 towards the power sensor 20, the remaining portion of the beam, indicated by reference number 58, is directed through the splitter 16 and through a shutter 60 to a lens 70. The shutter 60 includes a housing 62 through which extends an aperture 64. The aperture 64 is controlled by a shutter element 66. The shutter element 66 is moved by a motor 68 or a solenoid to either allow the passage of the light beam 58 through the shutter 60 or block the aperture 64 and thus prevent the transmission of the light beam 58 to the lens 70.

The lens 70 is a focusing lens that may be moved to adjust the width of the beam 58 relative to a length of vitreous tubing 110. The lens 70 is secured to a rack 72 that is moved through a pinion gear connected to a motor 74. The rotation of the shaft of the motor 74 moves the lens 70 towards or away from the tubing 110 to focus the beam 58 on the tubing 110, as desired.

As illustrated in FIG. 1, the beam 58 is focused at a point on the tubing 110 to provide maximum intensity of the beam 58 at the location of the focus point on the tubing 110.

Movement of the lens 70 changes the focus of the beam 58, and accordingly changes the concentration of the power of the beam relative to the tubing 110.

A motor 120, to which the tubing 110 is appropriately secured through a chuck or collet, in a spindle, rotates the tubing 110. The tubing 110 is also moved vertically relative to the beam 58 by means of a motor 130. The motor 130 drives a screw 132 to which a nut 122 is secured. The nut 122 is in turn secured to the motor 120 so that rotation of the screw 130 moves the nut 122, the motor 120, and the tubing 110 vertically relative to the beam 58.

The tubing 110 is, of course, preferably a vitreous form of silica, but may be other vitreous or crystalline materials and still fall within the scope of the present invention, and the heating thereof produces vapor and dust. The vapor and dust are removed from the tubing 110 by means of a vacuum head 140 that is connected to a vacuum conduit 142. A vacuum pump motor 144, illustrated in FIG. 5, in turn produces the vacuum necessary for the removal of the dust or particulates to an appropriate trap through the conduit 142.

Control of the apparatus is illustrated in FIG. 5, which comprises a block diagram of the various control elements involved. There are two control systems involved, a computer control system 200 and a manual control system 220. The manual control system 220 comprises override controls, which move the various elements to the starting positions as desired.

There are stepper motor drivers 202 that are connected to the motors 54 and 130. The motors 54 and 130 are stepper motors that move incrementally, as desired. The motor 54 moves the chopper 30 and its motor 24 towards and away from the beam 14. It will be noted that the chopper 30 is disposed at about a 45-degree angle to the light beam 14.

The motor 130 is a stepper motor, which moves the tubing 110 and its rotational motor 120 vertically relative to the beam 58.

To begin the operations, the shutter 66 must be withdrawn from the aperture 64. A shutter controller 204 controls the movement of the shutter 66.

A spindle rotation controller 206 controls the control of the spindle rotation motor 120, which rotates the tubing 110.

Finally, there is a lens position motor controller 208 that controls the motor 74 to move the lens 70 relative to the light beam 58 and to the tubing 110.

Each of the controllers may be manually adjusted by the plurality of manual controls 220. This allows the various controllers to be moved to the starting positions, as required. There is also a manual control for actuating the vacuum pump motor 144.

FIG. 6 is a view in partial section through union 260. The union 260 is shown in partial section, with its three bore portions 262, 264 and 266. It will be understood that during manufacture the beam remains fixed in place, and that the union 260 itself moves. For purposes of illustration however, the union 260 is shown in cross section.

Initially the focus of the carbon dioxide laser 12 is displaced outward from the union 260. Power is held steady at low power and the union 260 is moved through the laser 12 focal region under relatively rapid rotation and relatively rapid translation. The rotational speed and translational speed are adjusted to provide an outer groove or pattern 261, which is an undulation spacing, as desired on the outer diameter of the union 260. This outer pattern 263 on the outer diameter is translated, via melting, to an inner groove or pattern 261on the inner diameter, such as bores 262 and 266, but to a lesser (or greater) extent. More closely spaced patterning is accomplished using a tighter laser focus and slower translation. In an alternate embodiment, the undulating spacing pattern may be desired to have two different directions. In this embodiment, the union 260 may be “screwed on” to two capillaries at the same time, from opposing directions, as in a threaded cable tensioner. This pattern is accomplished by closing the shutter at mid-point and reopening it for the untreated half on the reverse rotational direction. It is recognized that a wide variety of different patterns, such as helical, evenly spaced grooves, non-evenly spaced grooves, a series of dimples, and the like may be produced and therefore also fall within the scope of the present invention.

Once the desired groove pattern is produced, a cone shape in the inner diameter of the union 260 is formed. The wide end of the bore 182 starts with low power to the laser, and as the power increases, the diameter of the bore decreases. Thus, the bore 182 tapers from a maximum diameter to the center portion 184, which is minimum diameter. The center portion 184 comprises a maximum power output of the carbon dioxide laser 12 focused on the union 260. The modulation of the power of the laser 12 is accomplished by movement of the chopper 30 into and out of the output beam 14 of the laser 12, as discussed above.

Alternatively, one might elect to split the carbon dioxide laser output to into tightly focused and less focused portions, imparting the glass tube simultaneously forming both the general conical and undulating thread pattern in a single pass through the beam. In some dimensional embodiments, it may be preferable to form the general conical tapers prior to the undulating thread pattern as well.

FIG. 7 is a view in partial section through a splitter precursor 260. The splitter precursor 260 is shown in partial section. The splitter precursor 260 includes at least an inner pattern 261 and three bore portions, a tapered bore portion 262, a curved central bore portion 264, and a second tapered bore portion 266. The bore portions 262 and 266 are mirror images of each other, while the bore portion 264, between the bores 262 and 266, comprises a generally oval shaped bore portion in which the diameter increases from a minimum to a maximum and then decreases from the maximum to the minimum. The bore portion 264 is a curved bore, as opposed to the linear taper of the bores 262 and 266. The central bore 264, rather than having a uniform cross section, as does the bore portion 264 of the coupler 240, has a curved configuration, as indicated above. The oval curvature of the bore 264 is accomplished by increased translational speed of the element 260 in the beam 58.

The translational speed of the element 260 is held constant while the power is increased to form the bore portion 262. When the minimum diameter of the bore portion 262 has been received, the power is held steady for a period of time. The translational speed of the element 260 is held steady during the formation of the bore 262. At a point in time corresponding to the beginning of the bore portion 264, when the power is held steady at maximum power the translation speed is increased to a maximum. The translation speed is then held steady.

At the end of the bore portion 264, the translational speed is decreased suddenly and reversed twice before returning to the speed employed to produce 262 for producing 266. The double reversal of translation serves to reheat the quartz before proceeding to formation of bore 266 providing similar conditions as were present when forming bore 262.

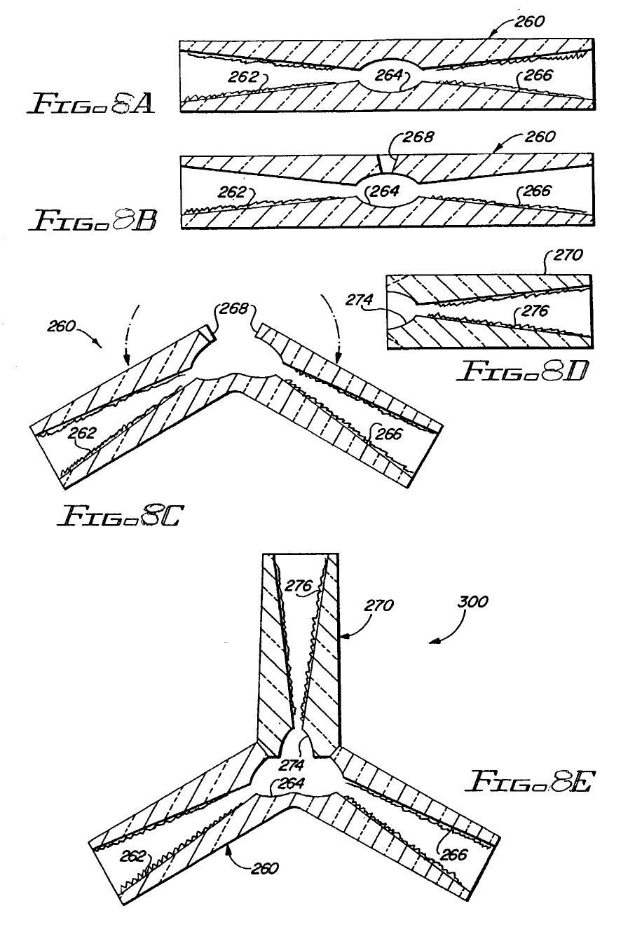

The fabrication of a splitter is illustrated in FIGS. 8A, 8B, 8C, and 8D.

In FIG. 8A, the splitter precursor 260 is shown in cross section. In FIG. 8B, the precursor element 260 is shown with a hole 268 that extends radially through the precursor at the curved bore 264. In FIG. 8C, the precursor element 260 is shown bent to receive a precursor half. The precursor half comprises the third leg of a complete splitter.

FIG. 8D comprises a view in partial section of a half precursor 270. The half precursor or precursor half 270 includes a half of a center curved bore 274 and a tapered bore 276. The bore 274 comprises essentially half of the bore 264, and the bore 276 corresponds to the bore 266. The half element 270 is one half of a precursor element 260. Accordingly, three precursor elements are used to make two splitter elements.

A splitter 300 is shown in FIG. 8E in partial section. The splitter 300 comprises the splitter 260 of FIG. 8B bent to form an inverted “V”, as shown in FIG. 8C, with the splitter half 270 appropriately secured to the hole or aperture 268, as widened by the bending of the splitter 260. The splitter half 270 is then appropriately fused to the bent precursor splitter 260 to form the splitter 300.

FIG. 9 is a view in partial section of a union 260 used as a coupling element, coupling together two capillary elements of similar diameters. The capillary elements include a capillary element 310 and a capillary element 312. The capillary element 310 is disposed in the bore 262, and the capillary element 312 is disposed in the bore 266. It will be noted that the ends of the capillary elements 310 and 312 are spaced apart an equal distance from the center 264 due to the symmetrical nature of the two bores 262 and 266 relative to the center bore portion 264. The inner pattern 261 contacts and securely holds the capillary elements 310 and 312 even if they have non-uniform cross-section and slightly dissimilar diameters, through differential compression of the polymer buffer coatings.

FIG. 10 is a view in partial section through the union 260 illustrating the coupling of capillary elements of dissimilar diameters. A capillary element 316 is shown disposed in the bore 262, and a capillary element 318 is shown disposed in the bore 266. The inner pattern 261, in this embodiment, contacts and securely holds the capillary elements 316 and 318 even if they have non-uniform cross-section and widely dissimilar diameters.

The diameter of the capillary element 316 is substantially larger than the diameter of the capillary element 318. Accordingly, there is a substantial difference in the distance between the center portion 264, which is the minimum diameter bore portion, and the inner end of the capillary element 316 relative to the inner end of the capillary element 318. The inner end of the capillary element 318 is much closer to the center bore portion 264 than is the inner end of the larger diameter capillary element 316.

Since the bore portions 262 and 266 have substantially identical tapers, there is a common centerline or longitudinal axis of the two bores. Accordingly, the capillary elements 316 and 318 are aligned coaxially with respect to each other as well as with respect to the bores 262 and 266. Similarly, the capillary elements 310 and 312 are coaxially aligned with each other since the bores 262 and 286 have substantially identical tapers.

The preferred embodiment of the invention is described above in the Description of Preferred Embodiments. While these descriptions directly describe the above embodiments, it is understood that those skilled in the art may conceive modifications and/or variations to the specific embodiments shown and described herein. Any such modifications or variations that fall within the purview of this description are intended to be included therein as well. Unless specifically noted, it is the intention of the inventors that the words and phrases in the specification and claims be given the ordinary and accustomed meanings to those of ordinary skill in the applicable art(s). The foregoing description of a preferred embodiment and best mode of the invention known to the applicant at the time of filing the application has been presented and is intended for the purposes of illustration and description. It is not intended to be exhaustive or to limit the invention to the precise form disclosed, and many modifications and variations are possible in the light of the above teachings. The embodiment was chosen and described in order to best explain the principles of the invention and its practical application and to enable others skilled in the art to best utilize the invention in various embodiments and with various modifications as are suited to the particular use contemplated.

What is claimed is:

1. A union for capillary elements comprising a tube, a bore within the tube, and a pattern in the inner diameter of the bore within the tube.

2. The union according to claim 1 wherein the pattern is helical.

3. The union according to claim 2 wherein the helical patterns reverses at some point within the union.

4. The union according to claim 1 wherein the pattern is evenly spaced grooves.

5. The union according to claim 1 wherein the pattern is non-evenly spaced grooves.

6. The union according to claim 1 wherein the pattern is a series of projections.

7. The union according to claim 2 wherein at least one portion of the bore is tapered.

8. The union according to claim 3 wherein at least one portion of the bore is tapered.

9. The union according to claim 4 wherein at least one portion of the bore is tapered.

10. The union according to claim 5 wherein at least one portion of the bore is tapered.

11. The union according to claim 6 wherein at least one portion of the bore is tapered.

12. A method for making a union with a linear or non-linear bore comprising the steps of providing a vitreous tube, exposing the vitreous tube to a laser beam such that the laser beam melts a portion of the vitreous tube while moving the vitreous tube in a patterned manner through the laser beam to create a patterned surface on the inner diameter of the bore within the vitreous tube.

13. The method according to claim 12 wherein the pattern is helical.

14. The method according to claim 13 wherein the helical pattern reverses at some point within the union, at the center for example.

15. The method according to claim 12 wherein the pattern is evenly spaced grooves.

16. The method according to claim 12 wherein the pattern is non-evenly spaced grooves.

17. The method according to claim 12 wherein the pattern is a series of projections.

18. The method according to claim 13 wherein at least one portion of the bore is tapered.

19. The method according to claim 14 wherein at least one portion of the bore is tapered.

20. The method according to claim 15 wherein at least one portion of the bore is tapered.

21. The method according to claim 16 wherein at least one portion of the bore is tapered.

22. The method according to claim 17 wherein at least one portion of the bore is tapered.
